(19) United States
(12) Patent Application Publication
(10) Pub. No.: US 2015/0032830 A1
(43) Pub. Date: Jan. 29, 2015

(54) Systems and Methods for Spam Interception

(71) Applicant: Tencent Technology (Shenzhen) Company Limited, Shenzhen (CN)

(72) Inventor: Yan Liu, Shenzhen (CN)

(73) Assignee: Tencent Technology (Shenzhen) Company Limited, Shenzhen (CN)

(21) Appl. No.: 14/219,528

(22) Filed: Mar. 19, 2014

Related U.S. Application Data
(63) Continuation of application No. PCT/CN2014/070089, filed on Jan. 3, 2014.

(30) Foreign Application Priority Data
Jul. 24, 2013 (CN) 201310313807.6

(51) Int. Cl. H04L 12/58

(52) U.S. Cl. CPC H04L 51/12
USPC 709/206

(57) ABSTRACT

Systems and methods are provided for intercepting spam messages. For example, a message including one or more first characters is received, the one or more first characters not being associated with predetermined formats; the one or more first characters are converted to one or more second characters associated with the predetermined formats; the one or more second characters are determined as a feature fingerprint of message; and in response to the feature fingerprint of the message being included in a database of sample feature fingerprints, the message is determined as a spam message and the message is intercepted.

### CROSS-REFERENCES TO RELATED APPLICATIONS

This application claims priority to Chinese Patent Application No. 201310313807.6, filed Jul. 2, 2013, incorporated by reference herein for all purposes.

### BACKGROUND OF THE INVENTION

Certain embodiments of the present invention are directed to computer technology. More particularly, some embodiments of the invention provide systems and methods for information processing. Merely by way of example, some embodiments of the invention have been applied to spam messages. But it would be recognized that the invention has a much broader range of applicability.

With the rapid development of Internet communication technologies, various spam messages including fraudulent information and illegal advertisements are regularly sent to users. Many users are deceived by these spam messages. Therefore, interception of spam messages becomes important to prevent users from being deceived.

Currently, the interception of spam messages often includes: an information-interception system receives spam samples from technicians. For example, a spam sample includes “CCTV ‘Feichang 6+1’: Congratulations you have been selected as ‘Feichang 6+1’ lucky audience and will receive a Second award. The prize includes a Samsung notebook Q40 and RMB 48,000. Please log in on www.cctv3yx.cn to collect your prize. The verification code is [1006]. Customer service: 400-6162-066.” The information-interception system extracts certain sample features from the sample spam, such as “Feichang 6+1,” “lucky audience,” “a Second award” and/or “prize.” The information-interception system stores the extracted sample features in a feature database.

Then, the information-interception system receives a message to be processed, and extracts some features (e.g., “Feichang 6+1,” “lucky audience,” “a Second award” or “gift”) from the message. Thereafter, the information-interception system calculates the degree of similarity between the extracted features and each sample feature stored in the feature database. Some sample features, such as “Feichang 6+1,” “lucky audience,” and “a Second award,” are selected due to the degree of similarity between these sample features and the extracted features being greater than a predetermined threshold. Then, the message is determined to be a spam message and intercepted.

But the above-noted conventional technology has some disadvantages. For example, the sample features stored in the feature database are extracted based on the texts of certain sample spam messages. When a publisher of the spam messages finds out that the spam messages are intercepted, the publisher can alter the texts in the spam messages immediately so as to quickly alter the features of the spam messages, which can cause the information-interception system to fail to identify and intercept the spam messages.

Hence it is highly desirable to improve the techniques for spam interception.

### BRIEF SUMMARY OF THE INVENTION

According to one embodiment, a method is provided for intercepting spam messages. For example, a message including one or more first characters is received, the one or more first characters not being associated with predetermined formats; the one or more first characters are converted to one or more second characters associated with the predetermined formats; the one or more second characters are determined as a feature fingerprint of message; and in response to the feature fingerprint of the message being included in a database of sample feature fingerprints, the message is determined as a spam message and the message is intercepted.

According to another embodiment, a device for intercepting spam messages includes: a reception module, a conversion module, a first determination module, and an interception module. The reception module is configured to receive a message including one or more first characters, the one or more first characters not being associated with predetermined formats. The conversion module is configured to convert the one or more first characters to one or more second characters associated with the predetermined formats. The first determination module is configured to determine the one or more second characters as a feature fingerprint of message. The interception module is configured to, in response to the feature fingerprint of the message being included in a database of sample feature fingerprints, determine the message as a spam message and intercept the message.

According to yet another embodiment, a non-transitory computer readable storage medium includes programming instructions for intercepting spam messages. The programming instructions are configured to cause one or more data processors to execute certain operations. For example, a message including one or more first characters is received, the one or more first characters not being associated with predetermined formats; the one or more first characters are converted to one or more second characters associated with the predetermined formats; the one or more second characters are determined as a feature fingerprint of message; and in response to the feature fingerprint of the message being included in a database of sample feature fingerprints, the message is determined as a spam message and the message is intercepted.

Depending upon embodiment, one or more benefits may be achieved. These benefits and various additional objects, features and advantages of the present invention can be fully appreciated with reference to the detailed description and accompanying drawings that follow.

### BRIEF DESCRIPTION OF THE DRAWINGS

FIG. 1 is a simplified diagram showing a method for intercepting spam messages according to one embodiment of the present invention.

FIG. 2 is a simplified diagram showing a method for intercepting spam messages according to another embodiment of the present invention.

FIG. 3 is a simplified diagram showing a device for intercepting spam messages according to one embodiment of the present invention.

### DETAILED DESCRIPTION OF THE INVENTION

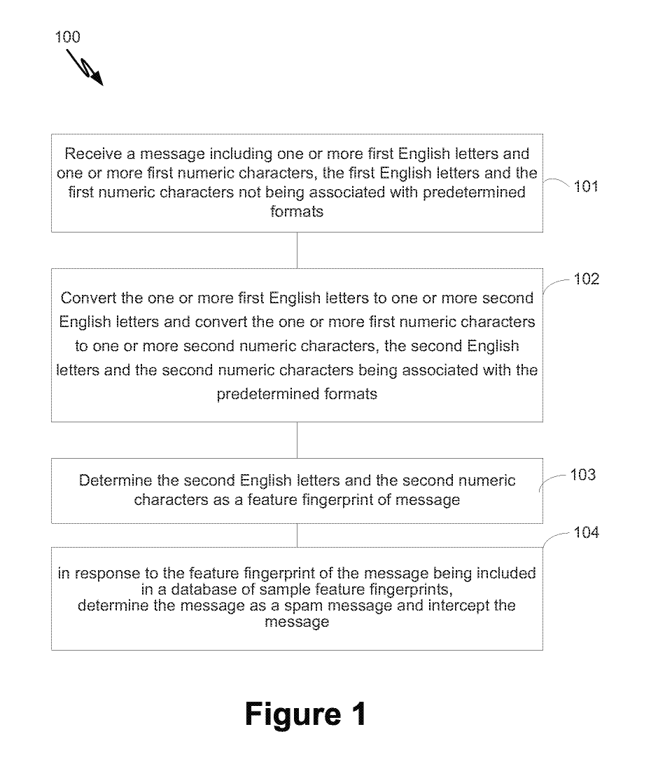

FIG. 1 is a simplified diagram showing a method for intercepting spam messages according to one embodiment of the present invention. This diagram is merely an example, which should not unduly limit the scope of the claims. One of ordinary skill in the art would recognize many variations, alternatives, and modifications. The method 100 includes at least the processes 101-104.

According to one embodiment, the process 101 includes: receiving a message including one or more first English letters and one or more first numeric characters, the first English letters and the first numeric characters not being associated with predetermined formats. For example, the process 102 includes: converting the one or more first English letters to one or more second English letters and converting the one or more first numeric characters to one or more second numeric characters, the second English letters and the second numeric characters being associated with the predetermined formats. In another example, the second English letters correspond to single-byte lowercase English letters, and the second numeric characters correspond to single-byte Arabic numeric characters.

According to another embodiment, the process 103 includes; determining the second English letters and the second numeric characters as a feature fingerprint of message. For example, the process 104 includes: in response to the feature fingerprint of the message being included in a database of sample feature fingerprints, determining the message as a spam message and intercepting the message. In another example, the process 102 includes: acquiring the one or more first English letters and the one or more first numeric characters in the message; based on at least information associated with a mapping between non-default characters not associated with the predetermined formats and default characters associated with the predetermined formats, converting the one or more first English letters to the one or more second English letters and converting the one or more first numeric characters to the one or more second numeric characters. In yet another example, acquiring the one or more first English letters and the one or more first numeric characters in the message includes: acquiring one or more second English letters represented by similar characters, one or more third English letters represented in multiple bytes, and/or one or more fourth uppercase English letters; and acquiring one or more second numeric characters represented by similar characters, one or more third numeric characters represented by Chinese characters, and/or one or more fourth numeric characters represented in multiple bytes.

According to yet another embodiment, the process 103 includes: extracting the second English letters and the second numeric characters; generating a character sequence based on at least information associated with the second English letters and the second numeric characters; and determining the character sequence as the feature fingerprint of message. For example, the method 100 further includes: in response to a character string in the database of sample feature fingerprints matching the feature fingerprint of the message or part of the feature fingerprint of the message, determining that the feature fingerprint of the message is included in the database of sample feature fingerprints. In another example, the method 100 further includes: receiving one or more third characters not associated with the predetermined formats and one or more fourth characters associated with the predetermined formats from an administrator, the one or more fourth characters corresponding to the one or more third characters; and storing the third characters and the fourth characters in a mapping between non-default characters not associated with the predetermined formats and default characters associated with the predetermined formats. In yet another example, the method 100 further includes: receiving a first sample feature fingerprint from an administrator; and storing the first sample feature fingerprint in the database of sample feature fingerprints.

In some embodiments, the database of sample feature fingerprints stores contact details of one or more publishers of spam messages as sample feature fingerprints so as to accurately intercept spam messages. Though it is easy and costs little for a publisher of spam messages to alter texts of the spam messages, it takes a longer time and costs much more for the publisher to change the contact details associated with the spam messages. For example, according to the method 100, English letters and numeric characters in a message (e.g., including both the texts of the message and the contact details of the publisher) are extracted, and the extracted English letters and numeric characters are determined as a feature fingerprint of the message. As an example, if the feature fingerprint of the message exists in the database of sample feature fingerprints, the message is then determined to be a spam message and can be intercepted immediately.

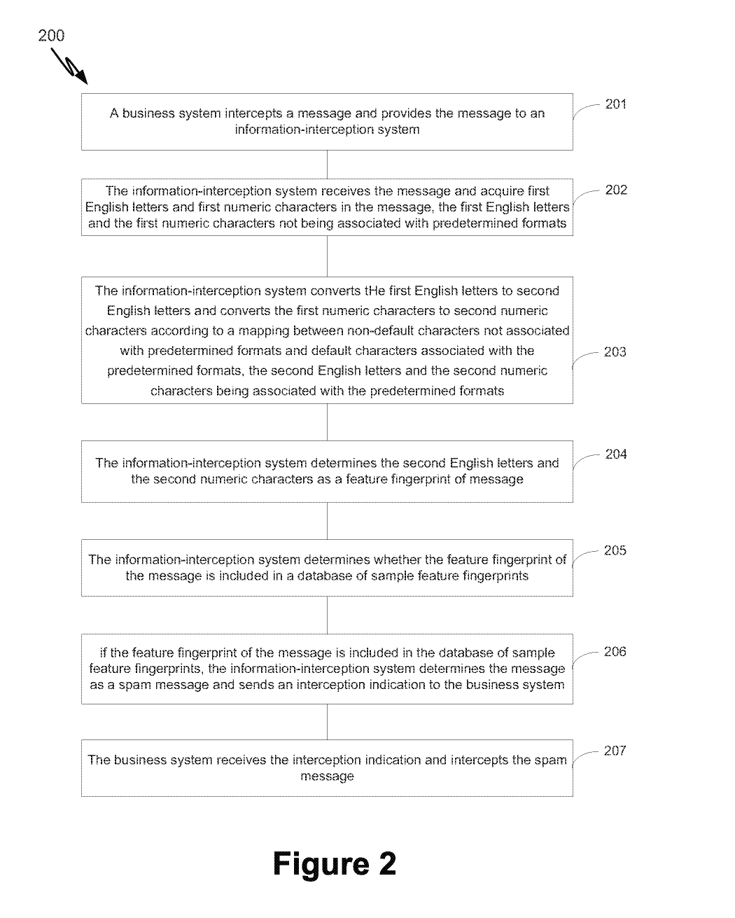

FIG. 2 is a simplified diagram showing a method for intercepting spam messages according to another embodiment of the present invention. This diagram is merely an example, which should not unduly limit the scope of the claims. One of ordinary skill in the art would recognize many variations, alternatives, and modifications. The method 200 includes at least the processes 201-207.

According to one embodiment, during the process 201, a business system intercepts a message and provides the message to an information-interception system. For example, the business system receives the message, and sends the message to the information-interception system via an interception interface. As an example, the message sent to the information-interception system is encoded universally (e.g., GBK encoding). In another example, during the process 202, the information-interception system receives the message and acquires first English letters and first numeric characters in the message, the first English letters and the first numeric characters not being associated with predetermined formats. As an example, the information-interception system receives the message via the interception interface. As another example, the information-interception system acquires the one or more first English letters including: one or more third English letters represented by similar characters, one or more fourth English letters represented in multiple bytes, and/or one or more fifth uppercase English letters; and acquires the one or more first numeric characters including; one or more third numeric characters represented by similar characters, one or more fourth numeric characters represented by Chinese characters, and/or one or more fifth numeric characters represented in multiple bytes.

According to another embodiment, during the process 203, the information-interception system converts the first English letters to second English letters and converts the first numeric characters to second numeric characters according to a mapping between non-default characters not associated with predetermined formats and default characters associated with the predetermined formats, the second English letters and the second numeric characters being associated with the predetermined formats. For example, the second English letters correspond to single-byte lowercase English letters, and the second numeric characters correspond to single-byte Arabic numeric characters. Tn another example, according to the mapping between non-default characters not associated with predetermined formats and default characters associated with the predetermined formats, the information-interception system converts English letters represented by similar characters in the message to single-byte lowercase English letters. In yet another example, according to the mapping between non-default characters not associated with predetermined formats and default characters associated with the predetermined formats, the information-interception system converts English letters represented in multiple bytes in the message to single-byte lowercase English letters. In yet another example, according to the mapping between non-default characters not associated with predetermined formats and default characters associated with the predetermined formats, the information-interception system converts the uppercase English letters in the message to single-byte lowercase English letters. Tn yet another example, according to the mapping between non-default characters not associated with predetermined formats and default characters associated with the predetermined formats, the information-interception system converts the numeric characters represented by similar characters in the message to single-byte Arabic numeric characters. In yet another example, according to the mapping between non-default characters not associated with predetermined formats and default characters associated with the predetermined formats, the information-interception system converts the numeric characters represented by Chinese characters in the message to single-byte Arabic numeric characters. In yet another example, according to the mapping between non-default characters not associated with predetermined formats and default characters associated with the predetermined formats, the information-interception system converts the numeric characters represented in multiple bytes in the message to single-byte Arabic numeric characters.

In certain embodiments, according to the method 200, the information-interception system intercepts spam messages even though a publisher of the spam messages changes the contact details to text-speak languages. Sometimes, when the publisher of the spam messages finds that the published spam messages are intercepted after various alterations to the texts of the spam messages, the publisher of the spam messages may mask the contact details in the spam messages in disguise (e.g., using text-speak languages). For example, according to the method 200, the information-interception system converts all English letters and numeric characters that are not associated with the predetermined formats (e.g., including the masked contact details) to English letters and numeric characters associated with the predetermined formats so that the contact details of the publisher can still be recognized to intercept spam messages accurately. As an example, a message includes “CCTV ‘Feichang 6+1’: Congratulations you have been selected as ‘Feichang 6+1’ lucky audience and will receive a Second award. The prize includes a Samsung notebook Q40 and RMB 48,000. Please log in on www.cctv3yx.cn to collect your prize. The verification code is [1006]. Customer service: 400-6162-066,” where “Second” is represented by a Chinese character corresponding to the number 2, and part of the name “Samsung” is represented by a Chinese character corresponding to the number 3. In another example, according to the mapping between non-default characters not associated with predetermined formats and default characters associated with the predetermined formats, the non-default characters in the message are converted to default characters, and the message is changed to “CCTV ‘Feichang 6+1’: Congratulations you have been selected as ‘Feichang 6+1’ lucky audience and will receive a Second award. The prize includes a Samsung notebook Q40 and RMB 48,000. Please log in on www.cctv3yx.cn to collect your prize. The verification code is [1006]. Customer service: 400-6162-066,” where “Second” is represented by an Arabic numeric character corresponding to the number 2, and part of the name “Samsung” is represented by an Arabic numeric character corresponding to the number 3.

In one embodiment, during the process 204: the information-interception system determines the second English letters and the second numeric characters as a feature fingerprint of message. For example, the information-interception system extracting the second English letters and the second numeric characters; generating a character sequence based on at least information associated with the second English letters and the second numeric characters; and determining the character sequence as the feature fingerprint of message. In some embodiments, generating the character sequence based on at least information associated with the second English letters and the second numeric characters includes: starting from a first character of the message, filtering character by character, retaining single-byte English letters and numeric characters in the message, and combining the retained single-byte English letters and numeric characters to generate the character sequence. For example, the character sequence generated based on the English letters and the numeric characters extracted from the message by the information-interception system includes: 616123q4048000www.cctv3yxcn10064006162066. This character sequence is determined as the feature fingerprint of the message.

In another embodiment, during the process 205: the information-interception system determines whether the feature fingerprint of the message is included in a database of sample feature fingerprints. For example, the information-interception system compares the sample feature fingerprints in the database of sample feature fingerprints with the feature fingerprint of the message. As an example, if a character string in the database of sample feature fingerprints matches with the feature fingerprint of the message or part of the feature fingerprint of the message (e.g., a sub-string of the feature fingerprint), then it is determined that the feature fingerprint of the message exists in the database of sample feature fingerprints. In another example, a Trie tree can be established in advance based on the sample feature fingerprints in the database of sample feature fingerprints. In yet another example, after a traversal scan of the feature fingerprint of the message, it can be determined whether the feature fingerprint of the message exists in the database of sample feature fingerprints. Comparing the sample feature fingerprints in the database of sample feature fingerprints with the feature fingerprint of the message through the Trie tree improves the efficiency for comparison, in certain embodiments. For example, if there is no character string in the database of sample feature fingerprints matches with the feature fingerprint of the message or part of the feature fingerprint of the message (e.g., a sub-string of the feature fingerprint), then it is determined that the feature fingerprint of the message does not exist in the database of sample feature fingetprints. In another example, the sample feature fingerprints in the database of sample feature fingerprints include “wwwcctv3yxcn,” “httppthqxzcn,” “098868229112” and “4006162066.” In yet another example, a traversal scan starts from the first character of the feature fingerprint of “616123q4048000wwwcctv3yxcn10064006162066” of the message, and as the character string “wwwcctv3yxcn” in the database of sample feature fingerprints matches with part of the feature print of the message, it is determined that the feature fingerprint of the message exists in the database of sample feature fingerprints.

In yet another embodiment, during the process 206, if the feature fingerprint of the message is included in the database of sample feature fingerprints, the information-interception system determines the message as a spam message and sends an interception indication to the business system. For example, if the feature fingerprint of the message exists in the database of sample feature fingerprints, then the information-interception system determines the message as a spam message and sends the interception indication to the business system via the interception interface. In another example, if the feature fingerprint of the message does not exist in the database of sample feature fingerprints, then the message is determined as a non-spam message, and a non-interception indication is sent to the business system.

In yet another embodiment, during the process 207, the business system receives the interception indication and intercepts the spam message. For example, the business system receives the interception indication via the interception interface, and intercepts the message according to the interception indication. In another example, an administrator discovers a first spam message that is not intercepted. If the first spam message includes a record that is not part of the existing mapping between non-default characters not associated with the predetermined formats and default characters associated with the predetermined formats, then the administrator enters the non-default characters and the corresponding default characters in the first spam message into the information-interception system which stores the received non-default characters and the corresponding default characters in the mapping between non-default characters not associated with the predetermined formats and default characters associated with the predetermined formats. In yet another example, an administrator discovers a second spam message from another source. If the second spam message has a record that is not part of the existing mapping between non-default characters not associated with the predetermined formats and default characters associated with the predetermined formats, then the administrator enters the non-default characters and the corresponding default characters of the second spam message into the information-interception system which stores the received non-default characters and the corresponding default characters in the mapping between non-default characters not associated with the predetermined formats and default characters associated with the predetermined formats. Thereafter, the administrator enters the first spam message and/or the second spam message from another source into the information-interception system, For example, the information-interception system receives the first spam message and/or the second spam message, and converts the non-default English letters and the non-default numeric characters in the first spam message and/or the second spam message to the default English letters and the default numeric characters according to the mapping between non-default characters not associated with the predetermined formats and default characters associated with the predetermined formats. In another example, the information-interception system also determines the converted English letters and the converted numeric characters as a feature fingerprint of the first spam message and/or the second spam message. In yet another example, the administrator extracts a character sequence associated with contact details from the feature fingerprint, and enters the extracted character sequence as a sample feature fingerprint into the information-interception system. In yet another example, the information-interception system receives the sample feature fingerprint entered by the administrator, and stores the received sample feature fingerprint into the database of sample feature fingerprints. The business system sends certain displayed information to the information-interception system periodically, and makes the information-interception system inspect whether the displayed information includes any spam messages that are not intercepted so that the business system can delete such spam messages, in certain embodiments.

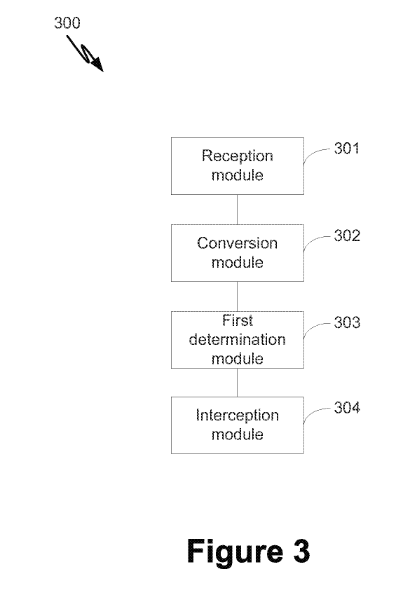

FIG. 3 is a simplified diagram showing a device for intercepting spam messages according to one embodiment of the present invention. This diagram is merely an example, which should not unduly limit the scope of the claims. One of ordinary skill in the art would recognize many variations, alternatives, and modifications. The device 300 includes a reception module 301, a conversion module 302, a first determination module 303 and an interception module 304.

According to one embodiment, the reception module 301 is configured to receive a message including one or more first characters, the one or more first characters not being associated with predetermined formats. For example, the conversion module 302 is configured to convert the one or more first characters to one or more second characters associated with the predetermined formats. In another example, the one or more first characters include one or more first English letters and one or more first numeric characters, and the one or more second characters include one or more second English letters and one or more second numeric characters. As an example, the second English letters correspond to single-byte lowercase English letters, and the second numeric characters correspond to single-byte Arabic numeric characters. In another example, the first determination module 303 is configured to determine the one or more second characters as a feature fingerprint of message. In yet another example, the interception module 304 is configured to, in response to the feature fingerprint of the message being included in a database of sample feature fingerprints, determine the message as a spam message and intercept the message.

According to another embodiment, the conversion module 302 includes: an acquisition unit configured to acquire the one or more first English letters and the one or more first numeric characters in the message; and a conversion unit configured to, based on at least information associated with a mapping between non-default characters not associated with the predetermined formats and default characters associated with the predetermined formats, convert the one or more first English letters to the one or more second English letters and convert the one or more first numeric characters to the one or more second numeric characters. For example, the acquisition unit includes: a first acquisition unit configured to acquire the one or more first English letters including: one or more third English letters represented by similar characters, one or more fourth English letters represented in multiple bytes, and/or one or more fifth uppercase English letters; and a second acquisition unit configured to acquire the one or more first numeric characters including: one or more third numeric characters represented by similar characters, one or more fourth numeric characters represented by Chinese characters, and/or one or more fifth numeric characters represented in multiple bytes.

According to yet another embodiment, the first determination module 303 includes: an extraction unit configured to extract the one or more second characters; and a determination unit configured to generate a character sequence based on at least information associated with the one or more second characters and determine the character sequence as the feature fingerprint of message.

In one embodiment, the device 300 further includes: a second determination module configured to, in response to a character string in the database of sample feature fingerprints matching the feature fingerprint of the message or part of the feature fingerprint of the message, determine that the feature fingerprint of the message is included in the database of sample feature fingerprints. For example, the device 300 further includes: a first storage module configured to receive one or more third characters not associated with the predetermined formats and one or more fourth characters associated with the predetermined formats from an administrator, the one or more fourth characters corresponding to the one or more third characters, and to store the third characters and the fourth characters in a mapping between non-default characters not associated with the predetermined formats and default characters associated with the predetermined formats. In another example, the device 300 further includes: a second storage module configured to receive a first sample feature fingerprint from an administrator and store the first sample feature fingerprint in the database of sample feature fingerprints.

According to one embodiment, a method is provided for intercepting spam messages. For example, a message including one or more first characters is received, the one or more first characters not being associated with predetermined formats; the one or more first characters are converted to one or more second characters associated with the predetermined formats; the one or more second characters are determined as a feature fingerprint of message; and in response to the feature fingerprint of the message being included in a database of sample feature fingerprints, the message is determined as a spam message and the message is intercepted. For example, the method is implemented according to at least FIG. 1, and/or FIG. 2.

According to another embodiment, a device for intercepting spam messages includes: a reception module, a conversion module, a first determination module, and an interception module. The reception module is configured to receive a message including one or more first characters, the one or more first characters not being associated with predetermined formats. The conversion module is configured to convert the one or more first characters to one or more second characters associated with the predetermined formats. The first determination module is configured to determine the one or more second characters as a feature fingerprint of message. The interception module is configured to, in response to the feature fingerprint of the message being included in a database of sample feature fingerprints, determine the message as a spam message and intercept the message. For example, the device is implemented according to at least FIG. 3.

According to yet another embodiment, a non-transitory computer readable storage medium includes programming instructions for intercepting spam messages. The programming instructions are configured to cause one or more data processors to execute certain operations. For example, a message including one or more first characters is received, the one or more first characters not being associated with predetermined formats; the one or more first characters are converted to one or more second characters associated with the predetermined formats; the one or more second characters are determined as a feature fingerprint of message; and in response to the feature fingerprint of the message being included in a database of sample feature fingerprints, the message is determined as a spam message and the message is intercepted. For example, the storage medium is implemented according to at least FIG. 1, and/or FIG. 2.

The above only describes several scenarios presented by this invention, and the description is relatively specific and detailed, yet it cannot therefore be understood as limiting the scope of this invention's patent. It should be noted that ordinary technicians in the field may also, without deviating from the invention's conceptual premises, make a number of variations and modifications, which are all within the scope of this invention. As a result, in terms of protection, the patent claims shall prevail.

For example, some or all components of various embodiments of the present invention each are, individually and/or in combination with at least another component, implemented using one or more software components, one or more hardware components, and/or one or more combinations of software and hardware components. In another example, some or all components of various embodiments of the present invention each are, individually and/or in combination with at least another component, implemented in one or more circuits, such as one or more analog circuits and/or one or more digital circuits. In yet another example, various embodiments and/or examples of the present invention can be combined.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to carry out the methods and systems described herein.

The systems ‘and methods’ data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, etc.) that contain instructions (e.g., software) for use in execution by a processor to perform the methods' operations and implement the systems described herein.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

The computing system can include client devices and servers. A client device and server are generally remote from each other and typically interact through a communication network. The relationship of client device and server arises by virtue of computer programs running on the respective computers and having a client device-server relationship to each other.

While this specification contains many specifics, these should not be construed as limitations on the scope or of what may be claimed, but rather as descriptions of features specific to particular embodiments. Certain features that are described in this specification in the context or separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

1. A method for intercepting spam messages, the method includes:
receiving a message including one or more first characters, the one or more first characters not being associated with predetermined formats;
converting the one or more first characters to one or more second characters associated with the predetermined formats;
determining the one or more second characters as a feature fingerprint of message; and
in response to the feature fingerprint of the message being included in a database of sample feature fingerprints,
determining the message as a spam message; and
intercepting the message.

2. The method of claim 1 wherein:
the one or more first characters include one or more first English letters and one or more first numeric characters; and
the one or more second characters include one or more second English letters and one or more second numeric characters, the second English letters corresponding to single-byte lowercase English letters, the second numeric characters corresponding to single-byte Arabic numeric characters.

3. The method of claim 2 wherein the converting the one or more first characters to one or more second characters associated with the predetermined formats includes:
acquiring the one or more first English letters and the one or more first numeric characters in the message;
based on at least information associated with a mapping between non-default characters not associated with the predetermined formats and default characters associated with the predetermined formats,
converting the one or more first English letters to the one or more second English letters; and
converting the one or more first numeric characters to the one or more second numeric characters.

4. The method of claim 3 wherein the acquiring the one or more first English letters and the one or more first numeric characters in the message includes:
acquiring at least one of: one or more second English letters represented by similar characters, one or more third English letters represented in multiple bytes, and one or more fourth uppercase English letters; and
acquiring at least one of: one or more second numeric characters represented by similar characters, one or more third numeric characters represented by Chinese characters, and one or more fourth numeric characters represented in multiple bytes.

5. The method of claim 2 wherein:
the one or more first English letters include at least one of one or more third English letters represented by similar characters, one or more fourth English letters represented in multiple bytes, and one or more fifth uppercase English letters; and
the one or more first numeric characters include at least one of: one or more third numeric characters represented by similar characters, one or more fourth numeric characters represented by Chinese characters, and one or more fifth characters represented in multiple bytes.

6. The method of claim 1 wherein the determining the one or more second characters as a feature fingerprint of message includes:
extracting the one or more second characters;
generating a character sequence based on at least information associated with the one or more second characters; and
determining the character sequence as the feature fingerprint of message.

7. The method of claim 1, further comprising:
in response to a character string in the database of sample feature fingerprints matching the feature fingerprint of the message or part of the feature fingerprint of the message, determining that the feature fingerprint of the message is included in the database of sample feature fingerprints.

8. The method of claim 1, further comprising:
receiving one or more third characters not associated with the predetermined formats and one or more fourth characters associated with the predetermined formats from an administrator, the one or more fourth characters corresponding to the one or more third characters: and
storing the third characters and the fourth characters in a mapping between non-default characters not associated with the predetermined formats and default characters associated with the predetermined formats.

9. The method of claim 1, further comprising:
receiving a first sample feature fingerprint from an administrator; and
storing the first sample feature fingerprint in the database of sample feature fingerprints.

10. A device for intercepting spam messages, comprising:
a reception module configured to receive a message including one or more first characters, the one or more first characters not being associated with predetermined formats;
a conversion module configured to convert the one or more first characters to one or more second characters associated with the predetermined formats;
a first determination module configured to determine the one or more second characters as a feature fingerprint of message; and
an interception module configured to, in response to the feature fingerprint of the message being included in a database of sample feature fingerprints, determine the message as a spam message and intercept the message.

11. The device of claim 10 wherein:
the one or more first characters include one or more first English letters and one or more first numeric characters; and
the one or more second characters include one or more second English letters and one or more second numeric characters, the second English letters corresponding to single-byte lowercase English letters, the second numeric characters corresponding to single-byte Arabic numeric characters.

12. The device of claim 11 wherein the conversion module includes:
an acquisition unit configured to acquire the one or more first English letters and the one or more first numeric characters in the message; and
a conversion unit configured to, based on at least information associated with a mapping between non-default characters not associated with the predetermined formats and default characters associated with the predetermined formats, convert the one or more first English letters to the one or more second English letters and convert the one or more first numeric characters to the one or more second numeric characters.

13. The device of claim 12 wherein the acquisition unit includes:
a first acquisition unit configured to acquire the one or more first English letters, the one or more first English letters including at least one of: one or more third English letters represented by similar characters, one or more fourth English letters represented in multiple bytes, and one or more fifth uppercase English letters; and
a second acquisition unit configured to acquire the one or more first numeric characters, the one or more first numeric characters including at least one of: one or more third numeric characters represented by similar characters, one or more fourth numeric characters represented by Chinese characters, and one or more fifth numeric characters represented in multiple bytes.

14. The device of claim 11 wherein:
the one or more first English letters include at least one of: one or more third English letters represented by similar characters, one or more fourth English letters represented in multiple bytes, and one or more fifth uppercase English letters; and
the one or more first numeric characters include at least one of: one or more third numeric characters represented by similar characters, one or more fourth numeric characters represented by Chinese characters, and one or more fifth numeric characters represented in multiple bytes.

15. The device of claim 10 wherein the first determination module includes:
an extraction unit configured to extract the one or more second characters; and
a determination unit configured to generate a character sequence based on at least information associated with the one or more second characters and determine the character sequence as the feature fingerprint of message.

16. The device of claim 10, further comprising:
a second determination module configured to, in response to a character string in the database of sample feature fingerprints matching the feature fingerprint of the message or part of the feature fingerprint of the message, determine that the feature fingerprint of the message is included in the database of sample feature fingerprints.

17. The device of claim 10, further comprising:
a first storage module configured to receive one or more third characters not associated with the predetermined formats and one or more fourth characters associated with the predetermined formats from an administrator, the one or more fourth characters corresponding to the one or more third characters, and to store the third characters and the fourth characters in a mapping between non-default characters not associated with the predetermined formats and default characters associated with the predetermined formats.

18. The device of claim 10, further comprising:
a second storage module configured to receive a first sample feature fingerprint from an administrator and store the first sample feature fingerprint in the database of sample feature fingerprints.

19. The device of claim 10, further comprising:
one or more data processors; and
a computer-readable storage medium;
wherein one or more of the reception unit, the conversion module, the first determination module, and the interception module are stored in the storage medium and configured to be executed by the one or more data processors.

20. A non-transitory computer readable storage medium comprising programming instructions for intercepting spam messages, the programming instructions configured to cause one or more data processors to execute operations comprising:
receiving a message including one or more first characters, the one or more first characters not being associated with predetermined formats;
converting the one or more first characters to one or more second characters associated with the predetermined formats;
determining the one or more second characters as a feature fingerprint, of message; and
in response to the feature fingerprint of the message being included in a database of sample feature fingerprints,
determining the message as a spam message; and
intercepting the message.
